(19) United States
(12) Patent Application Publication
(10) Pub. No.: US 2022/0136904 A1
(43) Pub. Date: May 5, 2022

(54) Digital dynamic infrared thermal imaging device

(71) Applicant: Tianlun Lai, Shenzhen (CN)

(72) Inventor: Tianlun Lai, Shenzhen (CN)

(21) Appl. No.: 17/454,629

(22) Filed: Nov. 12, 2021

(51) Int. Cl. G01J 5/02; G01J 5/03

(52) U.S. Cl. CPC G01J 5/027; G01J 2005/0077; G01J 5/03

(57) ABSTRACT

The disclosure provides a digital dynamic infrared thermal imaging device, which includes a control module, a power supply module, an interface module, a buffer module, an infrared module, a display module and a variable potentiometer; the control module is respectively connected with the interface module, the buffer module and the infrared module, The display module and the variable potentiometer are electrically connected; the power module is respectively electrically connected with the control module, the interface module, the buffer module, the infrared module, the display module and the variable potentiometer. The utility model can dynamically adjust the temperature monitoring range, perform multi-dimensional temperature thermal imaging monitoring of objects, and expand the temperature monitoring range of low-cost and low-resolution infrared thermal imaging sensor.

### CROSS REFERENCE TO RELATED APPLICATIONS

### Technical Field

The utility model belongs to the field of infrared monitoring and electronic technology, and specifically relates to a digital dynamic infrared thermal imaging device.

### Background

Infrared radiation was discovered in 1800, by Sir William Herschel who measured the temperature of each visible light band and noticed that when the thermometer was placed beyond the red band of the visible spectrum, there was a further increase in temperature. Herschel called this invisible light “infrared”. In 1929, Hungarian physicist Kalman Tihanyi invented the first infrared-sensitive camera based on the idea that all objects emit a heat signal in the form of infrared radiation. An infrared thermographic camera can detect this radiation in a similar way to an ordinary camera that can detect visible light.

Since objects above absolute zero emit infrared light, infrared thermal imaging technology absorbs the infrared light radiated by the target object, and then converts the light signal into an electrical signal, that is, converts infrared radiation that is invisible to the naked eye into a visible image. This technology is widely used in various fields and has the following characteristics: wide temperature measurement range, usually −170˜2000° C. (or need to add filter); high detection accuracy, can distinguish temperatures less than 0.1° C.; response The time is short, and the temperature field of the object can be measured within a few seconds; it can be used to measure small targets or point targets; it is a passive measurement and will not damage the measured temperature field.

At present, the application of infrared thermal imaging technology is becoming more and more popular, involving many fields such as civil aviation, security, border defense, industry, construction, transportation, outdoor and automation.

All existing thermal infrared monitoring device on the market, from low-resolution to high-resolution, the thermal infrared monitoring device monitoring imaging is achieved by measuring the temperature of the object and the surrounding temperature and projecting it to a fixed range of temperature and color temperature corresponding maps The expression of temperature. The range value measured by the thermal camera is generally at a fixed value (0˜300 degrees Celsius), and the temperature range in the general earth environment is −40˜48 degrees Celsius. Thermal infrared radiation will appear when the temperature reaches a certain level, for example, the temperature of steel reaches 600 When the temperature is lower than 600 degrees, then the object does not show flame or emit thermal infrared radiation, the human eye cannot perceive the temperature. The existing thermal camera partially solves the problem that the human eye cannot distinguish the temperature of the object, and can observe the change of the object temperature within the frame of a fixed and unified thermal corresponding color temperature map.

Existing thermal camera observe changes in object temperature within the framework of a fixed and unified thermal corresponding color temperature map. However, in the circuit design of the existing thermal camera, there is no circuit structure that can adjust and monitor the color temperature range. Therefore, in the process of temperature observation, the temperature monitoring display range of the thermal camera cannot be adjusted in real time.

### SUMMARY

Aiming at the above-mentioned shortcomings in the prior art, a digital dynamic infrared thermal imaging device provided by the present invention solves the problems existing in the prior art. In order to achieve the above-mentioned purpose of the invention, the technical solution adopted by the present utility model is: a digital dynamic infrared thermal imaging device, including a control module, a power supply module, an interface module, a buffer module, an infrared module, a display module, and a variable potentiometer;

The control module is electrically connected with the interface module, the buffer module, the infrared module, the display module and the variable potentiometer; the power module is respectively connected with the control module, the interface module, the buffer module, the infrared module, the display module and the variable potentiometer. The potentiometer is electrically connected.

Further, the control module includes a single-chip microcomputer U1 with a model number of ESP32-D0WDQ6, and the VDD3P3_CPU pin, VDD3P3_RTC pin, VDDA pin, VDD3P3 pin and VDD3P3_SDIO pin of the single-chip U1 are respectively connected to the +3.3V voltage.

Further, the interface module includes a MICRO_USB_SMT interface J1, a transistor chip U2 with a model of UMH3N, and a serial chip U3 with a model of CH340C;

The D− and D+ pins of the MICRO_USB_SMT interface J1 are respectively connected to the UD− and UD+ pins of the serial chip U3, and the TXD and RXD pins of the serial chip U3 are respectively connected to the GPIO3 of the single-chip microcomputer U1. The RTS# pin of the serial port chip U3 is connected to the first pin and the fifth pin of the transistor chip U2, and the DTR# pin of the serial port chip U3 is connected to the transistor chip U2. The second pin and the fourth pin are connected. The third pin and the sixth pin of the transistor chip U2 are respectively connected to the GPIO0 pin and the CHIP_PU pin of the micro-controller U1. The VCC pin of the serial port chip U3 is connected to the +3.3V voltage connection.

Further, the power supply module includes a voltage stabilizing chip U4 with a model of ME6211 and a power management chip U5 with a model of TP4054;

The IN pin of the voltage stabilizing chip U4 is a power input pin, the OUT pin of the voltage stabilizing chip U4 is a +3.3V voltage output terminal, and the IN pin of the voltage stabilizing chip U4 is connected to its EN pin, The IN pin of the voltage stabilizing chip U4 is connected to the source of the field effect transistor Q1, the EN pin of the voltage stabilizing chip U4 is connected to the cathode of the diode D1, and the anode of the diode D1 is connected to the source of the field effect transistor Q1. The gate, the VCC pin of the power management chip U5 are connected to the VBUS pin of the MICRO_USB_SMT interface J1, and the drain of the field effect transistor Q1 is connected to the BAT pin of the power management chip U5.

Further, the cache module includes a memory chip U6 with a model number of W25Q32FVSS. The pins, IO1 pins, IO2 pins, IO3 pins, CLK pins and IO0 pins of the memory chip U6 are respectively connected to the GPIO11 of the single-chip microcomputer U1. The pins, GPIO7 pins, GPIO10 pins, GPIO9 pins, GPIO6 pins and GPIO8 pins are connected, and the VCC pin of the storage chip U6 is connected to the +3.3V voltage.

Further, the display module includes a connecting terminal J2 and a display J3 with a model number of ST7789;

The first pin of the connecting terminal J2 is grounded, and the second pin of the connecting terminal J2 is connected to +3.3V voltage, one end of the grounding capacitor C19, one end of the resistor R7, and one end of the resistor R8. Pins 3 to 8 are connected with the 20th pin of the display J3, the 19th pin of the display J3, the 23rd pin of the display J3, the 22nd pin of the display J3, the 18th pin of the display J3 and One end of the resistor R10 is connected, and the 3rd to 8th pins of the terminal J2 are respectively connected to the GPIO18 pin, GPIO19 pin, GPIO23 pin, GPIO16 pin, GPIO5 pin and GPIO4 pin of the micro-controller U1 connect;

The 13th, 15th, and 17th pins of the display J3 are respectively connected to a +3.3V voltage, the 16th and 24th pins of the display J3 are grounded, and the The 14-pin is connected to one end of the resistor R9. The other end of the resistor R9 is connected to the ground resistor R11 and the collector of the transistor Q3. The base of the transistor Q3 is connected to the other end of the resistor R10. The emitter is grounded;

The other end of the resistor R7 is connected to the collector of the transistor Q2, the other end of the resistor R8 is respectively connected to the grounding capacitor C20 and the emitter of the transistor Q2, and the base of the transistor Q2 is grounded.

Further, the variable potentiometer includes a potentiometer W1, a first stationary end of the potentiometer W1 is grounded, a second stationary end of the potentiometer W1 is connected to a voltage of +3.3V, and the potentiometer The movable end of W1 is connected to the GPI34 pin of the micro-controller U1.

Further, the infrared module includes an infrared sensor U7 with a model number of AMG8833, the VDD pin of the infrared sensor U7 is respectively connected to a +3.3V voltage and a ground capacitor C1, the GND pin of the infrared sensor U7 is grounded, and the GND pin of the infrared sensor U7 is grounded. The SDA pin of the infrared sensor U7 is connected to the GPIO13 pin of the micro-controller U1, and the SCL pin of the infrared sensor U7 is connected to the GPIO15 pin of the micro-controller U1.

The beneficial effects of the utility model are:

This utility model provides a digital dynamic infrared thermal imaging device. During the monitoring process, the temperature monitoring range can be dynamically adjusted in real time. In addition to the observation and monitoring of the monitored object from the dimension of the surrounding environment and the internal temperature difference of the object, It can also conduct dynamic monitoring and observation of the monitored object from the dimension of the thermal map range that controls the limited temperature value, thereby performing multi-dimensional temperature thermal imaging monitoring of the object, expanding the low-cost and low-resolution thermal imaging sensor's applicable range.

The novel structure of the present invention is simple and easy to implement, can accurately monitor the temperature range of various objects, and has a wide range of application prospects.

### BRIEF DESCRIPTION OF THE DRAWINGS

FIG. 1 is a schematic diagram of a digital dynamic infrared thermal imaging device provided by the utility model.

FIG. 2 is a circuit diagram of the control module provided by the utility model.

FIG. 3 is an interface circuit diagram of the interface module provided by the utility model.

FIG. 4 is a circuit diagram of the serial port chip of the interface module provided by the utility model.

FIG. 5 is a drive circuit diagram of the interface module provided by the utility model.

FIG. 6 is a voltage stabilizing circuit diagram of the power supply module provided by the utility model.

FIG. 7 is a circuit diagram of the power supply connection of the power supply module provided by the utility model.

FIG. 8 is a circuit diagram of the cache module provided by the present invention.

FIG. 9 is an interface circuit diagram of the display module provided by the utility model.

FIG. 10 is a display circuit diagram of the display module provided by the present invention.

FIG. 11 is a first peripheral circuit diagram of the display module provided by the present invention.

FIG. 12 is a second peripheral circuit diagram of the display module provided by the present invention.

FIG. 13 is a circuit diagram of the variable potentiometer and infrared module provided by the utility model.

### DESCRIPTION OF THE EMBODIMENTS

The specific embodiment of the present invention are described below to facilitate those skilled in the art to understand the present invention. However, it should be clear that the present invention is not limited to the scope of the specific embodiment. For those of ordinary skill in the art, as long as Various changes are within the spirit and scope of the utility model defined and determined by the appended claims. These changes are obvious, and all inventions and creations that utilize the concept of the utility model are protected.

The embodiment of the present invention will be described in detail below with reference to the drawings.

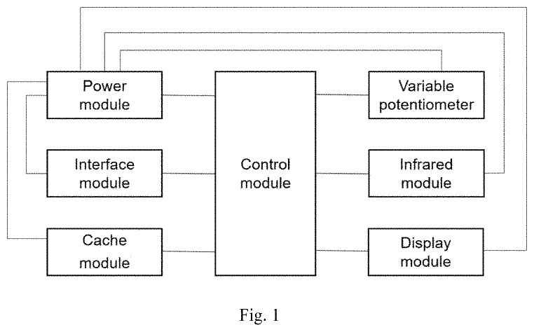

As shown in FIG. 1, a digital dynamic infrared thermal imaging device includes a control module, a power supply module, an interface module, a buffer module, an infrared module, a display module, and a variable potentiometer; the control module is respectively connected to the interface module and the buffer module, The infrared module, the display module and the variable potentiometer are electrically connected; the power module is respectively electrically connected with the control module, the interface module, the buffer module, the infrared module, the display module and the variable potentiometer.

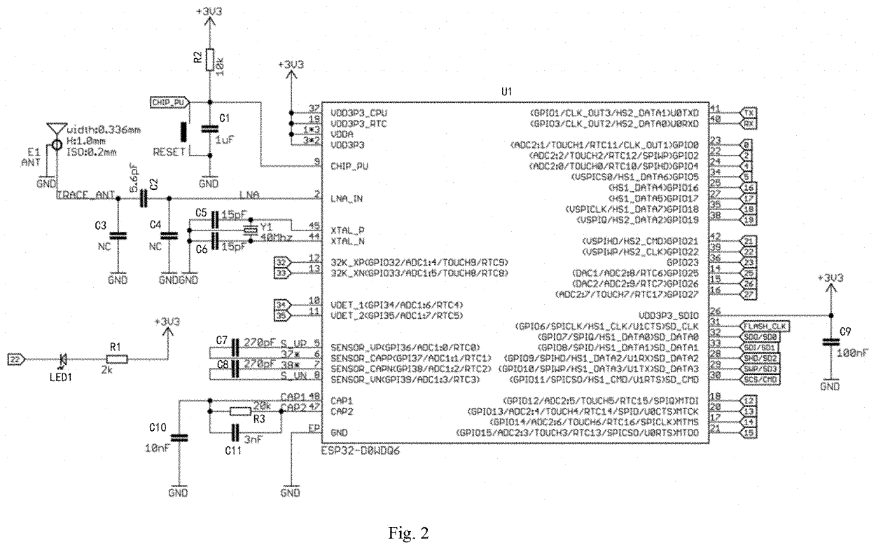

As shown in FIG. 2, the control module includes a single-chip microcomputer U1 with a model ESP32-D0WDQ6. The VDD3P3_CPU pin, VDD3P3_RTC pin, VDDA pin, VDD3P3 pin and VDD3P3_SDIO pin of the single-chip U1 have a voltage of +3.3V respectively. connect.

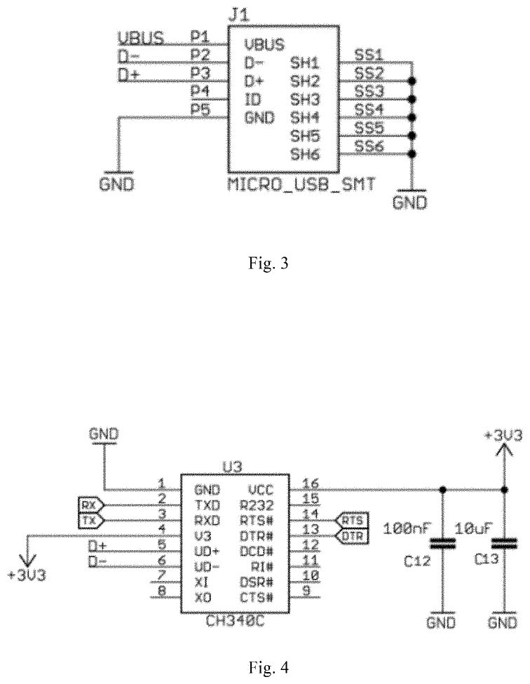

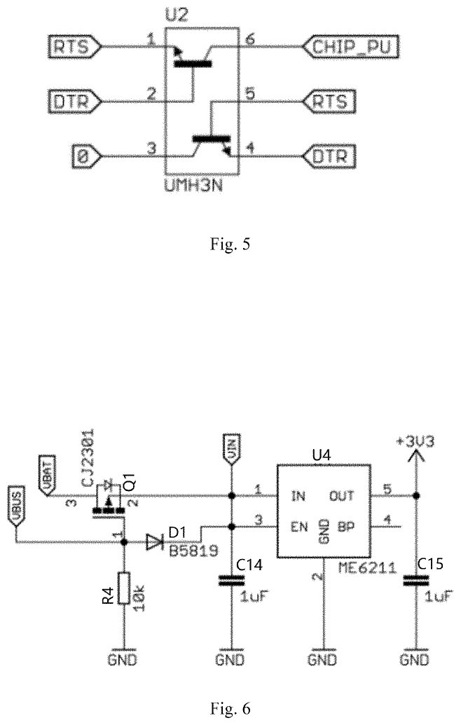

As shown in FIG. 3-5, the interface module includes a MICRO_USB_SMT interface J1, a transistor chip U2 with a model of UMH3N, and a serial chip U3 with a model of CH340C. The D− and D+ pins of the MICRO_USB_SMT interface J1 are respectively connected to the UD− and UD+ pins of the serial chip U3, and the TXD and RXD pins of the serial chip U3 are connected to the GPIO3 of the single-chip microcomputer U1. The RTS# pin of the serial port chip U3 is connected to the first pin and the fifth pin of the transistor chip U2, and the DTR# pin of the serial port chip U3 is connected to the transistor chip U2. The second pin and the fourth pin are connected. The third pin and the sixth pin of the transistor chip U2 are respectively connected to the GPIO0 pin and the CHIP_PU pin of the micro-controller U1. The VCC pin of the serial port chip U3 is connected to the +3.3V voltage connection.

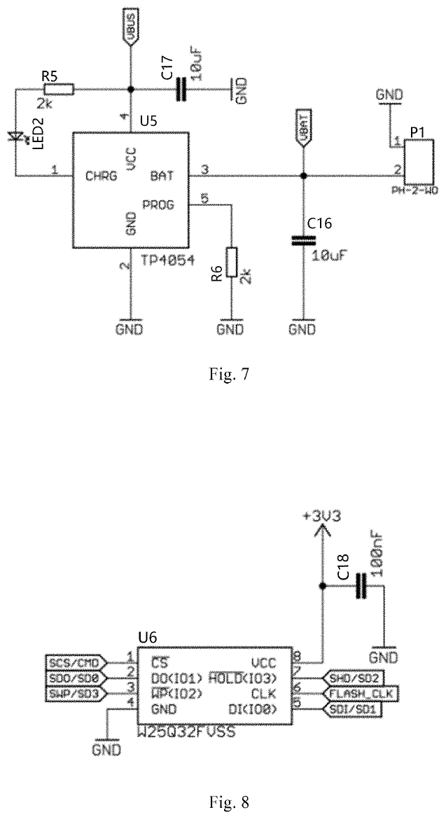

As shown in FIGS. 6-7, the power supply module includes a voltage stabilizing chip U4 with a model of ME6211 and a power management chip U5 with a model of TP4054. The IN pin of the voltage stabilizing chip U4 is a power input pin, the OUT pin of the voltage stabilizing chip U4 is a +3.3V voltage output terminal, and the IN pin of the voltage stabilizing chip U4 is connected to its EN pin, The IN pin of the voltage stabilizing chip U4 is connected to the source of the field effect transistor Q1, the EN pin of the voltage stabilizing chip U4 is connected to the cathode of the diode D1, and the anode of the diode D1 is connected to the source of the field effect transistor Q1. The gate, the VCC pin of the power management chip U5 are connected to the VBUS pin of the MICRO_USB_SMT interface J1, and the drain of the field effect transistor Q1 is connected to the BAT pin of the power management chip U5.

In this embodiment, the IN pin of the voltage regulator chip U4 can be connected to the positive electrode of the battery. The power supply module used +3.3V voltage output terminal to provide +3.3V voltage for the control module, interface module, cache module, infrared module, display module and variable potentiometer.

As shown in FIG. 8, the cache module includes a memory chip U6 with a model of W25Q32FVSS. The pins of the memory chip U6, IO1 pins, IO2 pins, IO3 pins, CLK pins and IO0 pins are connected to the single-chip microcomputer respectively. The GPIO11 pin, GPIO7 pin, GPIO10 pin, GPIO9 pin, GPIO6 pin and GPIO8 pin of U1 are connected, and the VCC pin of the storage chip U6 is connected to the +3.3V voltage.

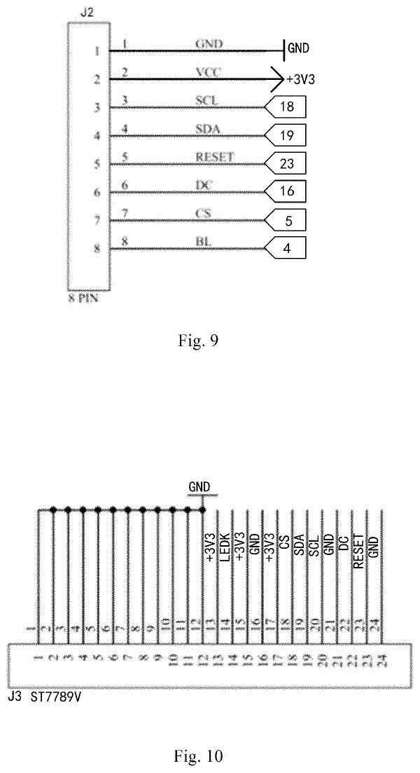

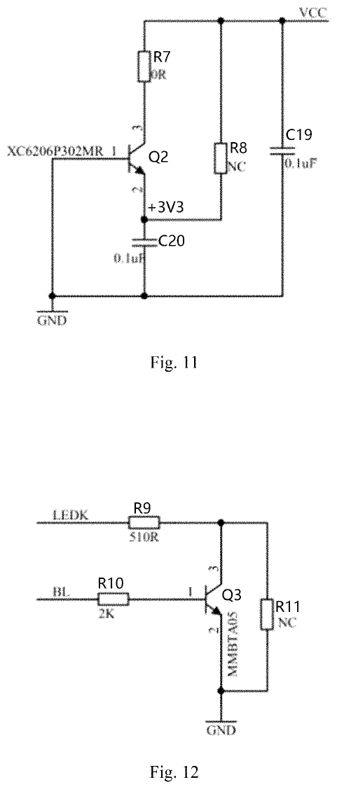

As shown in FIGS. 9-12, the display module includes a terminal J2 and a display J3 with a model number of ST7789. The first pin of the connecting terminal J2 is grounded, and the second pin of the connecting terminal J2 is connected to +3.3V voltage, one end of the grounding capacitor C19, one end of the resistor R7, and one end of the resistor R8. Pins 3 to 8 are connected with the 20th pin of the display J3, the 19th pin of the display J3, the 23rd pin of the display J3, the 22nd pin of the display J3, the 18th pin of the display J3 and One end of the resistor R10 is connected, and the 3rd to 8th pins of the terminal J2 are respectively connected to the GPIO18 pin, GPIO19 pin, GPIO23 pin, GPIO16 pin, GPIO5 pin and GPIO4 pin of the micro-controller U1 connect.

The 13th, 15th, and 17th pins of the display J3 are respectively connected to a +3.3V voltage, the 16th and 24th pins of the display J3 are grounded, and the The 14-pin is connected to one end of the resistor R9. The other end of the resistor R9 is connected to the ground resistor R11 and the collector of the transistor Q3. The base of the transistor Q3 is connected to the other end of the resistor R10. The emitter is grounded.

The other end of the resistor R7 is connected to the collector of the transistor Q2, the other end of the resistor R8 is respectively connected to the grounding capacitor C20 and the emitter of the transistor Q2, and the base of the transistor Q2 is grounded.

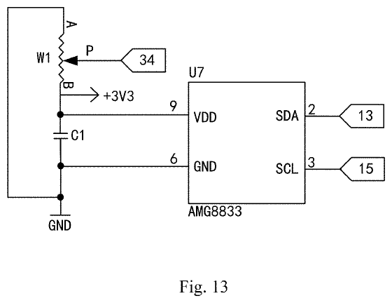

As shown in FIG. 13, the variable potentiometer includes a potentiometer W1, the first stationary end of the potentiometer W1 is grounded, and the second stationary end of the potentiometer W1 is connected to a +3.3V voltage, so The movable end of the potentiometer W1 is connected with the GPI34 pin of the single-chip microcomputer U1. The infrared module includes an infrared sensor U7 with a model number of AMG8833. The VDD pin of the infrared sensor U7 is connected to a +3.3V voltage and a ground capacitor C1. The GND pin of the infrared sensor U7 is grounded. The infrared sensor U7 The SDA pin is connected to the GPIO13 pin of the single-chip microcomputer U1, and the SCL pin of the infrared sensor U7 is connected to the GPIO15 pin of the single-chip U1.

In this embodiment, a filter capacitor can be set at the +3.3V voltage connection in the control module, the interface module, the buffer module, the infrared module, the display module, and the variable potentiometer.

The working principle of the utility model is:

(1) Supply power to the control module, interface module, buffer module, infrared module, display module and variable potentiometer through the power module.

(2) Measure the temperature through the infrared sensor U7, and transmit the measured temperature value image to the single-chip microcomputer U1.

(3) Adjust the variable potentiometer, read the current of the variable potentiometer through the single-chip microcomputer U1, convert the current to a value, and obtain the temperature range that needs to be monitored according to the obtained value; a value is preset in the single-chip U1 Correspondence with temperature range.

(4) According to the temperature range and the image of the measured temperature value, a thermodynamic color temperature map is generated through the single-chip microcomputer U1;

For example, the temperature value higher than the highest value of the temperature range should be displayed in red, the temperature value equal to the lowest value of the temperature range should be displayed in green, and the color from the lowest value of the temperature range to the highest value of the temperature range should be changed from green to red. You can get a thermodynamic color temperature map.

(5) Transmit the thermal color temperature map to the display J3, and display the thermal color temperature map through the display J3.

When generating the thermodynamic color temperature map, the temperature value image can be interpolated through the single-chip microcomputer U1, so that the resolution of the thermodynamic color temperature map is 32*32. In the working process, the data generated by the single-chip microcomputer U1 is buffered by the storage chip U6.

The utility model provides a digital dynamic infrared thermal imaging device. During the monitoring process, the temperature monitoring range can be dynamically adjusted in real time. In addition to observing and monitoring the monitored object from the dimension of the surrounding environment and the internal temperature of the object, it can also The monitored object conducts dynamic monitoring and observation from the dimension of controlling the size of the thermal map of the limited temperature value, so as to monitor the object with multi-dimensional temperature thermal imaging, which expands the application of low-cost and low-resolution thermal imaging sensor for temperature monitoring Scope. The present invention has a simple structure, is easy to implement, can accurately monitor the temperature range of various objects, and has a wide range of application prospects.

For details not described in this embodiment of the disclosure, please refer to the description in each of above embodiment.

What is claimed is:

1. A digital dynamic infrared thermal imaging device, characterized by comprising a control module, a power supply module, an interface module, a buffer module, an infrared module, a display module and a variable potentiometer; The control module is electrically connected with the interface module, the buffer module, the infrared module, the display module and the variable potentiometer; the power module is respectively connected with the control module, the interface module, the buffer module, the infrared module, the display module and the variable potentiometer. The potentiometer is electrically connected.

2. The digital dynamic infrared thermal imaging device according to claim 1, wherein the control module includes a single-chip microcomputer U1 with a model of ESP32-D0WDQ6, a VDD3P3_CPU pin, a VDD3P3_RTC pin, a VDDA pin of the single-chip microcomputer U1, VDD3P3 pin and VDD3P3_SDIO pin are connected to +3.3V voltage respectively.

3. The digital dynamic infrared thermal imaging device according to claim 2, wherein the interface module comprises a MICRO_USB_SMT interface J1, a transistor chip U2 with a model of UMH3N, and a serial chip U3 with a model of CH340C; The D− and D+ pins of the MICRO_USB_SMT interface J1 are respectively connected to the UD− and UD+ pins of the serial chip U3, and the TXD and RXD pins of the serial chip U3 are respectively connected to the GPIO3 of the single-chip microcomputer U1. The RTS# pin of the serial port chip U3 is connected to the first pin and the fifth pin of the transistor chip U2, and the DTR# pin of the serial port chip U3 is connected to the transistor chip U2. The second pin and the fourth pin are connected. The third pin and the sixth pin of the transistor chip U2 are respectively connected to the GPIO0 pin and the CHIP_PU pin of the micro-controller U1. The VCC pin of the serial port chip U3 is connected to the +3.3V voltage connection.

4. The digital dynamic infrared thermal imaging device according to claim 3, wherein the power supply module comprises a voltage stabilizing chip U4 with a model of ME6211 and a power management chip U5 with a model of TP4054; The IN pin of the voltage stabilizing chip U4 is a power input pin, the OUT pin of the voltage stabilizing chip U4 is a +3.3V voltage output terminal, and the IN pin of the voltage stabilizing chip U4 is connected to its EN pin, The IN pin of the voltage stabilizing chip U4 is connected to the source of the field effect transistor Q1, the EN pin of the voltage stabilizing chip U4 is connected to the cathode of the diode D1, and the anode of the diode D1 is connected to the source of the field effect transistor Q1. The gate, the VCC pin of the power management chip U5 are connected to the VBUS pin of the MICRO_USB_SMT interface J1, and the drain of the field effect transistor Q1 is connected to the BAT pin of the power management chip U5.

5. The digital dynamic infrared thermal imaging device according to claim 4, wherein the cache module comprises a memory chip U6 with a model number of W25Q32FVSS, and pins of the memory chip U6, IO1 pins, IO2 pins, and IO3 The pins, CLK pins and IO0 pins are respectively connected to the GPIO11 pin, GPIO7 pin, GPIO10 pin, GPIO9 pin, GPIO6 pin and GPIO8 pin of the micro-controller U1. The VCC pin of the storage chip U6 is connected to +3.3V voltage connection.

6. The digital dynamic infrared thermal imaging device according to claim 5, wherein the display module comprises a terminal J2 and a display J3 with a model number of ST7789; The first pin of the connecting terminal J2 is grounded, and the second pin of the connecting terminal J2 is connected to +3.3V voltage, one end of the grounding capacitor C19, one end of the resistor R7, and one end of the resistor R8. Pins 3 to 8 are connected with the 20th pin of the display J3, the 19th pin of the display J3, the 23rd pin of the display J3, the 22nd pin of the display J3, the 18th pin of the display J3 and One end of the resistor R10 is connected, and the 3rd to 8th pins of the terminal J2 are respectively connected to the GPIO18 pin, GPIO19 pin, GPIO23 pin, GPIO16 pin, GPIO5 pin and GPIO4 pin of the micro-controller U1 connect; The 13th, 15th, and 17th pins of the display J3 are respectively connected to a +3.3V voltage, the 16th and 24th pins of the display J3 are grounded, and the The 14-pin is connected to one end of the resistor R9. The other end of the resistor R9 is connected to the ground resistor R11 and the collector of the transistor Q3. The base of the transistor Q3 is connected to the other end of the resistor R10. The emitter is grounded; The other end of the resistor R7 is connected to the collector of the transistor Q2, the other end of the resistor R8 is respectively connected to the grounding capacitor C20 and the emitter of the transistor Q2, and the base of the transistor Q2 is grounded.

7. The digital dynamic infrared thermal imaging device according to claim 6, wherein the variable potentiometer comprises a potentiometer W1, the first fixed end of the potentiometer W1 is grounded, and the potentiometer W1 The second fixed terminal is connected to the +3.3V voltage, and the movable terminal of the potentiometer W1 is connected to the GPI34 pin of the single-chip microcomputer U1.

8. The digital dynamic infrared thermal imaging device according to claim 7, wherein the infrared module comprises an infrared sensor U7 with a model of AMG8833, and the VDD pin of the infrared sensor U7 is connected to the +3.3V voltage and the ground capacitance respectively. C1 is connected, the GND pin of the infrared sensor U7 is grounded, the SDA pin of the infrared sensor U7 is connected to the GPIO13 pin of the micro-controller U1, and the SCL pin of the infrared sensor U7 is connected to the GPIO15 pin of the micro-controller U1.
